(19) United States
(12) Patent Application Publication
(10) Pub. No.: US 2023/0397193 A1
(43) Pub. Date: Dec. 7, 2023

(54) JOINT TCI STATES FOR DL AND UL BEAM INDICATION

(71) Applicant: LENOVO (BEIJING) LIMITED, Beijing (CN)

(72) Inventors: Bingchao Liu, Beijing (CN); Chenxi Zhu, Fairfax, VA (US); Wei Ling, Beijing (CN); Yi Zhang, Beijing (CN); Lingling Xiao, Beijing (CN)

(21) Appl. No.: 18/029,276

(22) PCT Filed: Sep. 29, 2020
(86) PCT No.: PCT/CN2020/118880

§ 371 Date: Mar. 29, 2023

(51) Int. Cl. H04W 72/1268; H04W 52/08; H04W 52/24; H04W 76/20

(52) U.S. Cl. CPC H04W 72/1268; H04W 52/08; H04W 52/242; H04W 76/20

(57) ABSTRACT

Methods and apparatuses for transmitting and receiving PUSCH with joint TCI states are disclosed. A method comprises receiving a UL grant including a TCI field having a TCI codepoint pointing to one or two TCI states, wherein the UL grant schedules one or two PUSCH transmissions; and transmitting the PUSCH transmission (s) by the TX beam (s) determined by the TCI state (s) pointed to by the TCI codepoint.

### FIELD

The subject matter disclosed herein generally relates to wireless communications, and more particularly relates to methods and apparatuses for transmitting and receiving PUSCH with joint TCI states.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal) (UE), Transmission Configuration Indication (TCI), Physical Downlink Control Channel (PDCCH), Physical Downlink Shared Channel (PDSCH), (CSI-RS), Frequency Range 2 (FR2), Medium Access Control (MAC), control element (CE), receiver (RX), transmitter (TX), Downlink control information (DCI), Reference Signal (RS), Path Loss RS (PL-RS), quasi co-location (QCL), Sounding RS (SRS), SRS resource indicator (SRI), Synchronization Signal/PBCH Block (SSB), Physical Uplink Shared Channel (PUSCH), control resource set (CORESET), Transmission and Reception Point (TRP), Space Division Multiplexing (SDM), Frequency Division Multiplexing (FDM), Time Division Multiplexing (TDM), Quasi Co-location (QCL).

TCI state defined in NR Release 15 is used for DL RX beam indication for DL signals (e.g. PDCCH or PDSCH or CSI-RS) for a UE in FR2 (24.25 GHz˜52.6 GHz). Up to 128 TCI states can be configured for a UE in a BWP for DL RX beam indication by RRC signaling. A TCI state activation/deactivation MAC CE can be used to activate up to 8 TCI states from all configured TCI states. The TCI state for a PDSCH transmission can be dynamically indicated by the TCI field contained in the DCI scheduling the PDSCH transmission. That is, the value of the TCI field indicates one of the activated TCI states.

Spatial relation defined in NR Release 15 is used for UL TX beam indication for UL signals (e.g. higher layer parameter spatialRelationInfo for SRS or higher layer parameter PUCCH-spatialRelationInfo for PUCCH) in FR2. The UL TX beam for UL signals may be configured by RRC signaling (for SRS) or by MAC CE (for PUCCH). The UL TX beam for a PUSCH transmission is determined by the spatialRelationInfo configured for the SRS resource(s) indicated by the SRI field of the DCI scheduling the PUSCH transmission.

SSB and CSI-RS resources can be contained in the TCI state for DL signals and also can be contained in the spatial relations for UL signals. For a UE with beam correspondence, the DL RX beam indicated in the DL TCI states can also be used for UL TX beam indication.

Beam-specific power control is supported in NR Release 15. Different power control parameter sets are associated with different UL beams for PUSCH and PUCCH, in which a power control parameter set includes power control parameters such as P0, alpha, closed loop index and PL-RS.

The aim of the present invention is to provide a unified TCI framework for both DL and UL. In addition, the beam-specific power control for UL signal is also considered in the unified TCI framework.

### BRIEF SUMMARY

Methods and apparatuses for transmitting and receiving PUSCH with joint TCI states are disclosed.

In one embodiment, a method comprises receiving a UL grant including a TCI field having a TCI codepoint pointing to one or two TCI states, wherein the UL grant schedules one or two PUSCH transmissions; and transmitting the PUSCH transmission(s) by the TX beam(s) determined by the TCI state(s) pointed to by the TCI codepoint.

In one embodiment, the TX beam can be determined by a QCL-TypeD RS indicated by a first TCI state pointed to by the TCI codepoint. Alternatively, each of the TX beams is determined by a QCL-TypeD RS indicated by one of the two TCI states pointed to by the TCI codepoint.

In another embodiment, the method may further include receiving an RRC signaling to indicate whether the TCI field is included in the UL grant. If the TCI field is included in the UL grant, the TX beam(s) are determined by the TCI state(s) pointed to by the TCI codepoint when the UL grant including the TCI field is received. If the TCI field is not included in the UL grant, the TX beam(s) can be determined differently, for example, determined by spatial relation(s) configured for SRS resource(s) indicated by a SRI field of the UL grant, or alternatively determined by the TCI state or QCL assumption indicated for the CORESET transmitting the PDCCH carrying the UL grant.

In some embodiment, the method may further include receiving a MAC CE indicating each TCI state and its associated power control parameter set for each TCI codepoint. The power control parameter set may include P0, alpha, closed loop index and PL-RS. The MAC CE may include a CORESET Pool ID field to indicate a value of higher layer parameter CORESETPoolIndex configured for a CORESET transmitting the PDCCH carrying the UL grant, the TCI codepoint of the TCI field of which points to the one or two TCI states. The higher layer parameter CORESETPoolIndex is configured per CORESET for TRP identification.

In some embodiment, when multi-beam PUSCH repetition is not configured, one associated power control parameter set is associated with a first TCI state even if two TCI states are pointed to by one TCI codepoint. When multi-beam PUSCH repetition is configured, if two TCI states are pointed to by one TCI codepoint, each of the two TCI states is associated with one associated power control parameter set.

In another embodiment, a remote unit comprises a receiver and a transmitter, the receiver receives a UL grant including a TCI field has a TCI codepoint pointing to one or two TCI states, wherein the UL grant schedules one or two PUSCH transmissions; and the transmitter transmits the PUSCH transmission(s) by the TX beam(s) determined by the TCI state(s) pointed to by the TCI codepoint.

In one embodiment, a method comprises transmitting a UL grant including a TCI field having a TCI codepoint pointing to one or two TCI states, wherein the UL grant schedules one or two PUSCH transmissions; and receiving the PUSCH transmission(s) by the TX beam(s) determined by the TCI state(s) pointed to by the TCI codepoint.

In yet another embodiment, a base unit comprises a transmitter and a receiver, the transmitter transmits a UL grant including a TCI field has a TCI codepoint pointing to one or two TCI states, wherein the UL grant schedules one or two PUSCH transmissions; and the receiver receives the PUSCH transmission(s) by the TX beam(s) determined by the TCI state(s) pointed to by the TCI codepoint.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a TCI state activation/deactivation MAC CE according to a first sub-embodiment;

FIG. 2 illustrates a TCI state activation/deactivation MAC CE according to a second sub-embodiment;

FIG. 3 illustrates a TCI state activation/deactivation MAC CE according to a third sub-embodiment;

FIG. 4 illustrates a TCI state activation/deactivation MAC CE according to a fourth sub-embodiment

FIG. 5 illustrates an example of the TCI state activation/deactivation MAC CE according to the fourth sub-embodiment;

FIG. 6 is a schematic flow chart diagram illustrating an embodiment of a method;

FIG. 7 is a schematic flow chart diagram illustrating a further embodiment of a method; and

FIG. 8 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

According to the present invention, a unified TCI framework is proposed for the indication of both DL RX beam and UL TX beam by TCI state. From the point of view of UE, a DL beam is the RX beam of a DL signal, and a UL beam is the TX beam of a UL signal. Accordingly, in the following description, DL RX beam may be abbreviated as RX beam (or DL beam), and UL TX beam may be abbreviated as TX beam (or UL beam).

In NR release 15 and release 16, TCI state is indicated in a DCI for dynamic RX beam indication for PDSCH scheduled by DCI (e.g. DCI with format 1_1 (abbreviated as DCI format 1_1) or DCI with format 1_2 (abbreviated as DCI format 1_2)). One TCI state for DL beam indication can include one RS with a certain QCL type or two RSs with different QCL types (the two RSs can be different or the same). In FR2, a first RS with QCL-TypeA or QCL-TypeC is usually used for frequency and timing tracking, and a second RS with QCL-TypeD is usually used for beam indication. The RS with QCL-TypeA is used to obtain the Doppler shift, Doppler spread, average delay and delay spread parameters of a wireless channel. The RS with QCL-TypeC is used to obtain the Doppler shift and average delay parameter of a wireless channel. The RS with QCL-TypeD is used to obtain the spatial Rx parameter for receiving a DL signal. The RS with QCL-TypeD can be set as an SSB (SS/PBCH block) or an CSI-RS resource.

In NR release 15, spatial relation, which is used for TX beam indication for PUCCH and SRS, is configured by MAC CE for PUCCH or by RRC for SRS in PR2. The SSB and CSI-RS resource can be used as the spatial relation for UL, which means that the UE shall transmit the SRS resource or PUCCH resource with the same spatial domain transmission filter used for the reception of the reference CSI-RS or SSB indicated as the spatial relation for SRS or PUCCH resource.

If at least one of (1) and (2) is satisfied, a beam correspondence between TX beam and RX beam holds at UE or the UE has the capability of beam correspondence: (1) UE is able to determine a UE TX beam for the uplink transmission based on UE's downlink measurement on UE's one or more RX beams, and (2) UE is able to determine a UE RX beam for the downlink reception based on TRP's indication based on uplink measurement on UE's one or more TX beams. It thus can be seen that, for a UE with beam correspondence, SSB or CSI-RS can be set as both the value of TCI state for DL beam indication and spatial relation for UL beam indication. So, the DL TCI state in NR release 15 or 16 can be extended as the joint TCI states for DL and UL beam indication.

According to a first embodiment, the TX beam for a PUSCH transmission can be directly indicated in a DCI scheduling the PUSCH transmission. In particular, the TX beam can be indicated by a UL TCI field contained in the DCI. The UL TCI field contains a value that is a TCI codepoint. The TCI codepoint may point to one TCI state (in a scenario of single-TRP) or two TCI states (in a scenario of multi-TRP (e.g. two TRPs) where multi-beam PUSCH repetition can be configured). For ease of discussion, “a TCI codepoint of the UL TCI field points to TCI state(s)” may be referred to as “the UL TCI field points to TCI state(s)”.

For a UE with beam correspondence, it is reasonable that the UE use the same beam direction for UL transmission as that for DL reception. Therefore, the same TCI states as those for RX beam indication for DL signals (e.g. PDSCH, PDCCH, and CSI-RS) can be used for TX beam indication for UL signals (e.g. PUSCH). Therefore, the configured TCI states (up to 128 configured TCI states) for RX beam indication for DL signals defined in NR Release 15 can be extended as the joint TCI states configured for both RX beam indication for DL signals and TX beam indication for UL signals. That is, the configured TCI states (up to 128 configured TCI states) can be also used for TX beam indication for a PUSCH scheduled by a DCI.

The value (i.e. TCI codepoint) of the UL TCI field contained in UL grant (i.e. DCI, e.g., DCI format 0_1 or DCI format 0_2) can point to one or two activated TCI states. Considering that both RX beam and TX beam are required in FR2, UE shall expect that each of the TCI state(s) pointed to by the UL TCI field should include an RS with QCL-TypeD (also referred to as “QCL-TypeD RS”). Accordingly, the UE determines the TX beam(s) according to the RS(s) with QCL-TypeD included in the TCI state(s) pointed to by the UL TCI field. In particular, if two RSs are included in one activated TCI state pointed to by the UL TCI field contained in the DCI, one TX beam for the scheduled PUSCH is determined according to the QCL-TypeD RS among the two RSs. If one RS is included in one activated TCI state pointed to by the UL TCI field contained in the DCI, one TX beam for the scheduled PUSCH is determined according to the one RS.

The UL TCI field may not always be included in the DCI (e.g. DCI format 0_1 or DCI format 0_2) scheduling a PUSCH transmission. A higher layer parameter (e.g., tci-PresentInDCI-ForFormat0_1) can be configured per CORESET to indicate whether UL TCI field is contained in the DCI (e.g. DCI format 0_1) scheduling the PUSCH transmission. Similarly, a higher layer parameter tci-PresentInDCI-ForFormat0_2 can be configured per CORESET to indicate whether UL TCI field is contained in the DCI format 02.

If the higher layer parameter tci-PresentInDCI-ForFormat0_1 (or tci-PresentInDCI-ForFormat0_2) is configured (i.e. it is set to “enabled”), the UE assumes that the UL TCI field is included in the DCI format 0_1 (or DCI format 0_2), and determines the TX beam(s) for a PUSCH transmission according to the TCI state(s) pointed to by the UL TCI field contained in the DCI format 0_1 (or DCI format 0_2) scheduling the PUSCH transmission. If the higher layer parameter tci-PresentInDCI-ForFormat0_1 (or tci-PresentInDCI-ForFormat0_2) is not configured (i.e. it is set to “disabled”), the UE assumes the UL TCI field is NOT contained in the DCI format 0_1 (or DCI format 0_2), two alternative UE behaviors for determining the TX beam(s) for a PUSCH transmission when the UL TCI field is NOT contained in the DCI scheduling the PUSCH transmission are proposed.

Option 1: The UE determines the TX beam for the PUSCH transmission according to existing method defined in NR Release 15. That is, the UE determines the TX beam(s) for the PUSCH transmission according to the spatialRelationInfo configured for the SRS resource(s) indicated by the SRI field contained in the DCI (DCI format 0_1 or DCI format 0_2) scheduling the PUSCH transmission.

Option 2: The UE determines the TX beam for the PUSCH according to the TCI state or QCL assumption (in particular, the QCL-typeD RS of the TCI state or QCL assumption) applied for the CORESET used for transmitting PDCCH carrying the DCI (DCI format 0_1 or DCI format 0_2) scheduling the PUSCH transmission. A CORESET (Control Resource Set) defines a set of frequency and time resources used for PDCCH transmission. Incidentally, for a UE equipped with multiple panels, if the panel for reception of the PDCCH is not the activated panel for PUSCH transmission, the UE further determines the panel for PUSCH transmission by the panel-ID related information contained in the SRS resource(s) indicated by the SRI field contained in the DCI (DCI format 0_1 or DCI format 0_2) scheduling the PUSCH transmission.

For example, CORESET #0, CORESET #1 and CORESET #2 are configured for a UE in a BWP. A higher layer parameter tci-PresentInDCI-ForFormat0_1 is configured (i.e. is set as “enabled”) in CORESET #1 but configured neither in CORESET #0 nor in CORESET #2 (i.e. is set as “disabled” in CORESET #0 and in CORESET #2). The UE shall assume that the UL TCI field is contained in the DCI format 0_1 transmitted from CORESET #1 and shall determine the transmitting beam(s) for the PUSCH scheduled by the DCI format 0_1 according to the QCL-TypeD RS(s) contained in the TCI state(s) pointed to by the UL TCI field.

In addition, the UE shall assume that the DCI format 0_1 from CORESET #0 or from CORESET #2 does not contain the UL TCI field and shall determine the TX beam(s) for the PUSCH transmission scheduled by the DCI format 0_1 from CORESET #0 or from CORESET #2 according to the spatial relation(s) configured for the SRS resource(s) indicated by the SRI field contained in the DCI format 0_1 (with option 1) or according to the QCL-TypeD RS included in the TCI state configured for PDCCH (i.e. configured for the CORESET transmitting the PDCCH) carrying the scheduling DCI format 0_1 (with option 2).

According to a second embodiment, the TCI state activation/deactivation MAC CE is enhanced.

Traditionally, up to 8 TCI states can be activated by a TCI state activation/deactivation MAC CE, so that the activated TCI state(s) can be pointed to by the DL TCI field of the scheduling DCI.

In the unified TCI framework proposed by the present invention, the TCI state activation/deactivation MAC CE is enhanced to support both DL beam indication and UL beam indication. Each activated TCI state is one of the 128 configured TCI states. Therefore, each TCI state to be activated can be represented by a TCI state ID with 7 bits. The unified TCI framework also support that one TCI codepoint points to one TCI state (in scenario of single-TRP) or one or two TCI states (in scenario of multi-TRP).

In addition, beam-specific power control is supported in NR Release 15 and NR Release 16. UE can track up to 4 PL-RSs for all UL signals. Therefore, the PL-RS or even all power control parameters including P0, alpha, closed loop index and PL-RS should be associated with each activated TCI state for the dynamic TX beam indication for PUSCH. P0 is used to configure the target receive power of gNB. Alpha (0<alpha<=1) is a power compensation factor. Closed loop index is used to indicate one index of two close loops. PL-RS is used to indicate a DL RS for the UE for DL pathloss estimation. That is, the TCI state activation/deactivation MAC CE is further enhanced to support beam-specific power control for PUSCH transmission.

According to the second embodiment, a power control parameter set that includes parameters of P0, alpha, closed loop index and PL-RS is associated with each activated TCI state that can be pointed to by UL TCI codepoint. SRI-PUSCH-PowerControl defined in NR Release 15 or 16 as shown in Table 1 can be used as the power control parameter set indication.

TABLE 1

| | |
|---|---|
| SRI-PUSCH-PowerControl ::= | SEQUENCE |
| sri-PUSCH-PowerControlId | SRI-PUSCH-PowerControlId, |
| sri-PUSCH-PathlossReferenceRS-Id | PUSCH-PathlossReferenceRS-Id, |
| sri-P0-PUSCH-AlphaSetId | P0-PUSCH-AlphaSetId, |
| sri-PUSCH-ClosedLoop Index | ENUMERATED { i0, i1 } |
| } | |
| PUSCH-PathlossReferenceRS-r16 ::= | SEQUENCE { |
| pusch-PathlossReferenceRS-Id-r16 | PUSCH-PathlossReferenceRS-Id-r16, |
| referenceSignal-r16 | CHOICE { |
| ssb-Index-r16 | SSB-Index, |
| csi-RS-Index-r16 | NZP-CSI-RS-ResourceId |
| } | |
| } | |

Up to 32 power control parameter sets can be configured for a UE in a BWP. Therefore, the power control parameter set associated with an activated TCI state can be represented by a power control parameter set ID with 5 bits.

Incidentally, the power control parameter set associated with the activated TCI state is only used for the scheduled PUSCH transmission. On the other hand, when the activated TCI state is pointed to by the DL TCI field, the associated power control parameter set with the activated TCI state is omitted (not considered).

Depending on different scenarios of single TRP or multiple TRPs (e.g. two TRPs), different TCI state activation/deactivation MAC CE formats for joint TCI states are proposed.

For each of the TCI state activation/deactivation MAC CE formats, up to 128 TCI states are configured by RRC signaling according to UE capability. In particular, up to 128 TCI-StateIDs are configured to identify the configured TCI states.

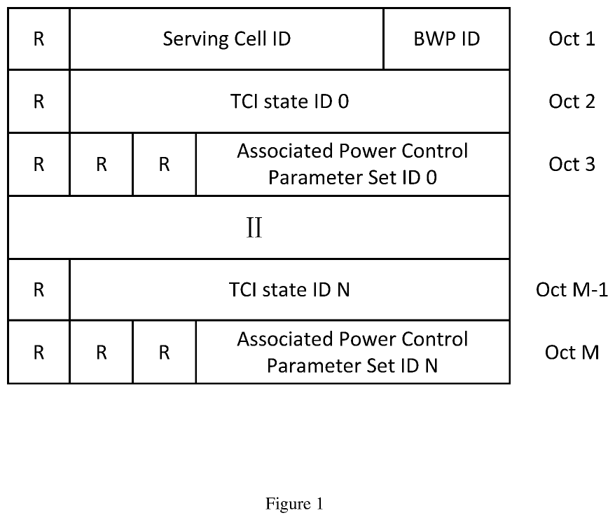

According to a first sub-embodiment, an example of the TCI state activation/deactivation MAC CE for the scenario of single TRP is illustrated in FIG. 1. In the scenario of single TRP for both PDSCH and PUSCH, a TCI codepoint points to one TCI state. The TCI state activation/deactivation MAC CE according to the first sub-embodiment has the following fields:

Serving cell ID (with 5 bits): This field indicates the identity of the serving cell for which the MAC CE applies.

BWP ID (with 2 bits): This field indicates the identity of the BWP for which the MAC CE applies.

TCI state ID n (n is from 0 to N): Each of TCI state ID n fields occupies 7 bits and indicates a TCI state identified by one of the 128 TCI-StateIDs configured by RRC signaling, where n is the index of the codepoint of the TCI field in DCI (e.g. DCI format 0_1 or 0_2 for scheduling PUSCH transmission, or DCI format 1_1 or 1_2 for scheduling PDSCH transmission). N is for example 7, so that eight TCI states (identified by TCI state IDs 0 to 7) can be activated by the MAC CE. In other words, the candidate TCI codepoints of the TCI field of the scheduling DCI are 0 to 7 corresponding to 3-bits TCI field in DL DCI and UL DCI.

Associated power control parameter set ID n (n is from 0 to N): Each of associated power control parameter set ID n fields occupies 5 bits and indicates a power control parameter set including P0, Alpha, Closed loop index and PathlossReferenceRS (PL-RS) associated with the TCI state indicated by TCI state ID n field. The associated power control parameter set ID n fields only apply to the scheduled PUSCH transmission.

R: Reserved bit, set to 0.

The TCI state activation/deactivation MAC CE according to the first sub-embodiment has M octets. The value of M basically depends on the value of N (e.g. M=2*(N+1)+1). When N is 7, M is 17.

According to the first sub-embodiment, eight (when N is 7) TCI states, each of which is associated with a power control parameter set, are activated. The UL TCI field in a DCI scheduling a PUSCH transmission or the DL TCI field in a DCI scheduling a PDSCH transmission may point one of the activated TCI states identified by TCI state ID n, as a basis of determining the TX beam for the scheduled PUSCH or the RX beam for the scheduled PDSCH. For the scheduled PUSCH, the power control parameters are determined according to the associated power control parameter set identified by associated power control parameter set ID n.

Multi-DCI based multi-TRP PDSCH transmission, which can be configured per cell, is supported in NR release 16. In the scenario of multi-DCI based multi-TRP (e.g. two TRPs) PDSCH, a DCI transmitted from one TRP can schedule a PDSCH transmission to be transmitted from the one TRP, and a DCI transmitted from another TRP can schedule a PDSCH transmission to be transmitted from the other TRP. Similarly, multi-DCI based multi-TRP PUSCH is also supported, a DCI transmitted from one TRP can schedule a PUSCH transmission to be transmitted to the one TRP, and a DCI transmitted from another TRP can schedule a PUSCH transmission to be transmitted to the other TRP.

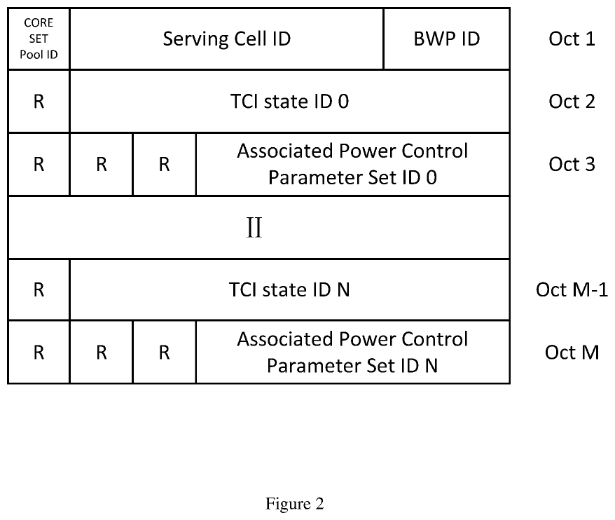

According to a second sub-embodiment, an example of the TCI state activation/deactivation MAC CE for the scenario of multi-DCI based multi-TRP PDSCH and PUSCH is illustrated in FIG. 2. The TCI state activation/deactivation MAC CE according to the second sub-embodiment has the following fields:

CORESET Pool ID (with 1 bit): This field indicates a value of higher layer parameter CORESETPoolIndex configured for a CORESET transmitting the PDCCH carrying the DCI, the TCI codepoint of the DL or UL TCI field of which points to one of the activated TCI states identified by TCI state ID n fields (and the associated power control parameter set identified by associated power control parameter set ID n) contained in this MAC CE. The higher layer parameter CORESETPoolIndex is configured per CORESET for TRP identification. The CORESET Pool ID field is set to 1 to indicate that the MAC CE is applied for the DL and UL transmission scheduled by a DCI carried in PDCCH transmitted from CORESET configured with CORESETPoolIndex=1. The CORESET Pool ID field is set to 0 to indicate that the MAC CE is applied for the DL and UL transmission scheduled by a DCI carried in PDCCH transmitted from CORESET configured with CORESETPoolIndex=0. In other words, the MAC CE containing the CORESET Pool ID field with a different value applies to a DCI transmitted from a different TRP.

Serving cell ID; BWP ID; TCI state ID n (n is from 0 to N); and associated power control parameter set ID n (n is from 0 to N): these fields are completely the same as those of the first sub-embodiment.

R: Reserved bit, set to 0.

The TCI state activation/deactivation MAC CE according to the second sub-embodiment has M octets. The value of M basically depends on the value of N (e.g. M=2*(N+1)+1). When N is 7, M is 17.

According to the second sub-embodiment, eight (when N is 7) TCI states, each of which is associated with a power control parameter set, are activated for each of multiple TRPs (e.g. two TRPs).

Single-DCI based multi-TRP PDSCH transmission, which can be configured per cell, is supported in NR release 16. In the scenario of single-DCI based multi-TRP (e.g. two TRPs) PDSCH, a DCI transmitted from one TRP may schedule a PDSCH transmission to be transmitted from two TRPs. Accordingly, two different TCI states may be pointed to by one TCI codepoint of DL TCI field of the DCI.

With ideal backhaul for potential multi-beam PUSCH repetition, single-DCI based multi-TRP (e.g. two TRPs) PUSCH is also supported, in which a DCI transmitted from one TRP can schedule a PUSCH transmission to be transmitted to two TRPs with multi-beam repetition. Similarly, two different TCI states may be pointed to by one TCI codepoint of UL TCI field of the DCI.

Different multiplexing manners can be supported in single-DCI based multi-TRP (e.g. two TRPs) PDSCH transmission: SDM (Space Division Multiplexing), 1-DM (Frequency Division Multiplexing) and TDM (Time Division Multiplexing).

On the other hand, only TDM is supported in single-DCI based multi-TRP (e.g. two TRPs) PUSCH transmission.

SDM based PDSCH transmission is supported for higher throughput traffic. In the scenario of single-DCI based multi-TRP (e.g. two TRPs) SDM based PDSCH, a DCI transmitted from one TRP can schedule a PDSCH transmission to be transmitted from two TRPs with two different beams with the same frequency and time resources. Single-DCI based multi-TRP (e.g. two TRPs) SDM based PUSCH is not supported.

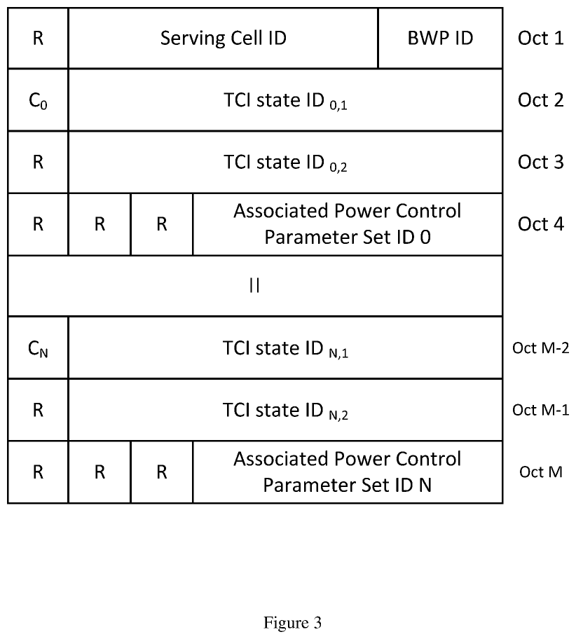

According to a third sub-embodiment, an example of the TCI state activation/deactivation MAC CE for the scenario of single-DCI based multi-TRP SDM based PDSCH, that also supports PUSCH transmission without multi-beam repetition, is illustrated in FIG. 3. The TCI state activation/deactivation MAC CE according to the third sub-embodiment has the following fields:

Serving cell ID (with 5 bits): This field indicates the identity of the serving cell for which the MAC CE applies.

BWP ID (with 2 bits): This field indicates the identity of the BWP for which the MAC CE applies.

Cₙ (n is from 0 to N): Each of Cₙ fields occupies 1 bit and indicates whether the octet (Oct) containing TCI state ID_{n,2} is present. If the Cₙ field is set to “1”, the octet containing TCI state ID_{n,2} is present. It means that a TCI codepoint with index n points to two TCI states identified by TCI state ID_{n,1} and TCI state ID_{n,2}. If the Cₙ field is set to “0”, the octet containing TCI state ID_{n,2} is not present. It means that a TCI codepoint with index n points to one TCI state identified by TCI state ID_{n,1}. N is for example 7.

TCI state ID_{n,j} (n is from 0 to N; j is 1 or 2): Each of TCI state ID_{n,j} fields occupies 7 bits and indicates a TCI state identified by one of the 128 TCI-StateIDs configured by RRC signaling, where n is the index of the codepoint of the TCI field of the DCI. TCI state ID_{n,j} denotes the j^{th} TCI state pointed to by the n^{th} codepoint of the TCI field of the DCI. For example, a first TCI codepoint with TCI state ID_{0,1} and TCI state ID_{0,2} are pointed to by the TCI codepoint value 0 of the TCI field of the DCI. For another example, a second TCI codepoint with TCI state ID_{1,1} and TCI state ID_{1,2} are pointed to by the TCI codepoint value 1 of the TCI field of the DCI. If Cₙ field is set to “0” (i.e. TCI state ID_{n,2} is not present), the n^{th} codepoint of the TCI field of the DCI points to one TCI state identified by TCI state ID_{n,1}. The maximum number of activated TCI codepoint is 8 (when N is 7). The maximum number of TCI states mapped to a TCI codepoint is 2.

Associated power control parameter set ID n (n is from 0 to N): Each of associated power control parameter set ID n fields occupies 5 bits and indicates a power control parameter set including P0, Alpha, Closed loop index and PathlossReferenceRS (PL-RS) associated with the TCI state indicated by TCI state ID_{n,1} field. The associated power control parameter set ID n fields are only for PUSCH. Since single-DCI based multi-TRP (e.g. two TRPs) SDM based PUSCH is not configured, the TCI codepoint of the UL TCI field of the DCI scheduling PUSCH should point to only one activated state. Accordingly, the TCI state ID_{n,1} field (n is from 0 to N) is used to determine one TX beam for PUSCH transmission without multi-beam repetition. The associated power control parameter set ID n that is associated with the TCI state identified by TCI state ID_{n,1} is used to determine the power control parameters for the single shot PUSCH.

R: Reserved bit, set to 0.

The TCI state activation/deactivation MAC CE according to the third sub-embodiment has M octets. The value of M basically depends on the value of N and the number of Cₙ fields being equal to 1 (or being equal to 0). Suppose N is 7, M is maximally 25 (the number of Cₙ fields being equal to 1 is 8 or the number of Cₙ fields being equal to 1 is 0), and minimally 17 (the number of Cₙ fields being equal to 1 is 0 or the number of Cₙ fields being equal to 1 is 8).

When the TCI states are activated by the MAC CE according to the third sub-embodiment, a first TCI state (i.e. identified by TCI state ID_{n,1}) pointed to by the n^{th} codepoint of the UL TCI field of the DCI is used to determine one TX beam for PUSCH transmission without multi-beam repetition. Needless to say, when the TCI state identified by TCI state ID_{n,1} is determined, the associated power control parameter set identified by associated power control parameter set ID n is determined as the power control parameters for the PUSCH transmission without multi-beam repetition.

According to the third sub-embodiment, the multi-beam PUSCH repetition is not configured. Therefore, the associated power control parameter set IDₙ is only associated with one (i.e. a first) TCI state indicated by TCI state ID_{n,1}.

FDM or TDM based PDSCH repetition schemes are configured to be supported for the UE for higher reliable transmission. In the scenario of single-DCI based multi-TRP (e.g. two TRPs) FDM or TDM based PDSCH, a DCI transmitted from one TRP can schedule a PDSCH to be transmitted from two TRPs with two different beams and two different sets of frequency resources or different time resources. TDM based multi-beam PUSCH repetition scheme can also be configured for higher reliable UL transmission in the scenario of single-DCI based multi-TRP (e.g. two TRPs), in which a DCI transmitted from one TRP can schedule a PUSCH to be transmitted to two TRPs with two different beams associated with different power control parameter sets and with different time resources.

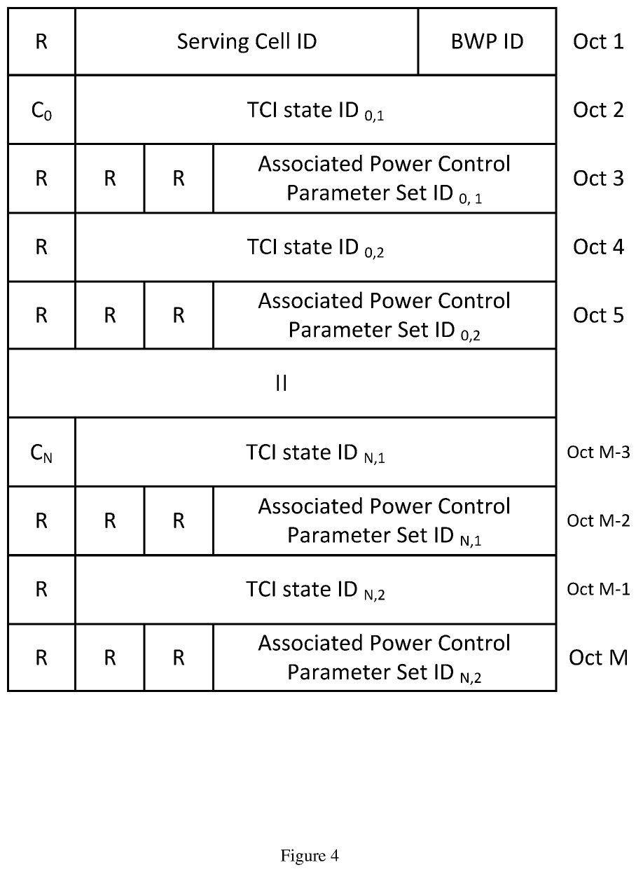

According to a fourth sub-embodiment, an example of the TCI state activation/deactivation MAC CE for the scenario of single-DCI based multi-TRP FDM or TDM based PDSCH and TDM based PUSCH is illustrated in FIG. 4. The TCI state activation/deactivation MAC CE according to the fourth sub-embodiment has the following fields:

Serving cell ID (with 5 bits): This field indicates the identity of the serving cell for which the MAC CE applies.

BWP ID (with 2 bits): This field indicates the identity of the BWP for which the MAC CE applies.

Cₙ (n is from 0 to N): Each of Cₙ fields occupies 1 bit and indicates whether the octet (Oct) containing TCI state ID_{n,2} and the octet (Oct) containing associated power control parameter set ID_{n,2} is present. If the Cₙ field is set to “1”, the octet containing TCI state ID_{n,2} and the octet containing associated power control parameter set ID_{n,2} are present. It means that a TCI codepoint with index n points to two TCI states identified by TCI state ID_{n,1} and TCI state ID_{n,2}. If the Cₙ field is set to “0”, the octet containing TCI state ID_{n,2} and the octet containing associated power control parameter set ID_{n,2} are not present. It means that a TCI codepoint with index n points to one TCI state identified by TCI state ID_{n,1}. N is for example 7.

TCI state ID_{n,1} (n is from 0 to N): Each of TCI state ID_{n,1} fields occupies 7 bits and indicates a TCI state identified by one of the 128 TCI-StateIDs configured by RRC signaling, where n is the index of the codepoint of the TCI field of the DCI. TCI state ID_{n,1} denotes the first TCI state pointed to by the n^{th} codepoint of the TCI field of the DCI. The maximum number of activated TCI codepoints is 8 (when N is 7).

Associated power control parameter set ID_{n,1} (n is from 0 to N): Each of associated power control parameter set ID_{n,1} fields occupies 5 bits and indicates a power control parameter set including P0, Alpha, Closed loop index and PathlossReferenceRS (PL-RS) associated with the TCI state indicated by TCI state ID_{n,1} field. The associated power control parameter set ID_{n,1} fields only apply for PUSCH transmission.

TCI state ID_{n,2} (n is from 0 to N): Each of TCI state ID_{n,2} fields is present when the Cₙ field is set to “1”. Each TCI state ID_{n,2} field occupies 7 bits and indicates a TCI state identified by one of the 128 TCI-StateIDs configured by RRC signaling, where n is the index of the codepoint of the TCI field of the DCI. TCI state ID_{n,2} denotes the second TCI state pointed to by the n^{th} codepoint of the TCI field of the DCI.

Associated power control parameter set ID_{n,2} (n is from 0 to N): Each of associated power control parameter set ID_{n,2} fields is present when the Cₙ field is set to “1”. Each of associated power control parameter set ID_{n,2} fields occupies 5 bits and indicates a power control parameter set including P0, Alpha, Closed loop index and PathlossReferenceRS (PL-RS) associated with the TCI state indicated by TCI state ID_{n,2} field. The associated power control parameter set ID_{n,2} fields only apply for PUSCH.

R: Reserved bit, set to 0.

The TCI state activation/deactivation MAC CE according to the fourth sub-embodiment has M octets. The value of M basically depends on the value of N and the number of Cₙ fields being equal to 1 (or being equal to 0). Suppose N is 7, M is maximally 33 (the number of Cₙ fields being equal to 1 is 8 or the number of Cₙ fields being equal to 0), and minimally 17 (the number of Cₙ fields being equal to for the number of Cₙ fields being equal to 0).

When the TCI states are activated by the MAC CE according to the fourth sub-embodiment, a first TCI state (i.e. identified by TCI state ID_{n,1}) and a second TCI state (i.e. identified by TCI state ID_{n,2}) (if present) pointed to by the n^{th} codepoint of the UL TCI field of the DCI are used to determine two TX beams for PUSCH with multi-beam repetition. Needless to say, when the TCI states identified by TCI state ID_{n,1} and TCI state ID_{n,2} (if present) are determined, the associated power control parameter sets identified by associated power control parameter set ID_{n,1} and associated power control parameter set ID_{n,2} (if present) are determined as the power control parameters for the PUSCH with multi-beam repetition.

According to the fourth sub-embodiment, the multi-beam PUSCH repetition is configured. Therefore, two associated power control parameter sets identified by associated power control parameter set ID_{n,1} and associated power control parameter set ID_{n,2} are respectively associated with two activated TCI states identified by TCI state ID_{n,1} and TCI state ID_{n,2} pointed to by one TCI codepoint.

As a whole, four sub-embodiments propose four different formats of TCI state activation/deactivation MAC CEs for joint TCI states. All of four TCI state activation/deactivation MAC CEs with different formats can be used for activating TCI states for both PDSCH and PUSCH. The fields “associated power control parameter set ID n” or “associated power control parameter set ID_{n,1} or ID_{n,2}” are only applied for PUSCH transmission.

The TCI state activation/deactivation MAC CE according to the first sub-embodiment applies to the scenario of single TRP based PDSCH and PUSCH transmission. When the TCI states are activated by the TCI state activation/deactivation MAC CE according to the first sub-embodiment, the UL TCI field in a DCI scheduling a PUSCH transmission points to one activated TCI state identified by a TCI state ID n field, the QCL-typeD RS contained in the one activated TCI state and the power control parameter set identified by the associated power control parameter set ID n are used to determine the TX beam and the TX power for the scheduled PUSCH transmission.

The TCI state activation/deactivation MAC CE according to the second sub-embodiment applies to the scenario of multi-DCI based multi-TRP PDSCH and PUSCH. When the TCI states are activated by the TCI state activation/deactivation MAC CE according to the second sub-embodiment, the UL TCI field in a DCI, that is carried by a PDCCH transmitted from a CORESET having a CORESETPoolIndex value and schedules a PUSCH transmission, points to one activated TCI state identified by a TCI state ID n field of the TCI state activation/deactivation MAC CE according to the second sub-embodiment having a CORESET Pool ID field having the CORESETPoolIndex value. The QCL-typeD RS contained in the one activated TCI state and the power control parameter set identified by associated power control parameter set ID n are used to determine the transmitting beam and the transmit power for the scheduled PUSCH transmission.

The TCI state activation/deactivation MAC CE according to the third sub-embodiment applies to the scenario of single-DCI based multi-TRP SDM based PDSCH transmission and for PUSCH transmission without multi-beam repetition. When the TCI states are activated by the MAC CE according to the third sub-embodiment, the UL TCI field in a DCI scheduling a PUSCH transmission points to one activated TCI state identified by TCI state ID_{n,1}. The QCL-typeD RS contained in the one activated TCI state identified by TCI state ID_{n,1} and the power control parameter set identified by associated power control parameter set ID n are used to determine the transmitting beam and the transmit power for the scheduled PUSCH transmission.

The TCI state activation/deactivation MAC CE according to the fourth sub-embodiment applies to the scenario of single-DCI based multi-TRP FDM or TDM based PDSCH transmission and TDM based PUSCH transmission. When the TCI states are activated by the MAC CE according to the fourth sub-embodiment, the TCI codepoint with a value n of the UL TCI field in a DCI scheduling a PUSCH transmission points to two activated TCI states identified by TCI state ID_{n,1} and TCI state ID_{n,2} (if present). If TCI state ID_{n,2} is not present (i.e. Cₙ is set to 0), the TCI codepoint with a value n of the UL TCI field in a DCI scheduling a PUSCH transmission points to one activated TCI state identified by TCI state ID_{n,1}. The QCL-typeD RS contained in the activated TCI state identified by TCI state ID_{n,1} and the power control parameter set identified by associated power control parameter set ID_{n,1} are used to determine a first TX beam and first power control parameter set for the scheduled PUSCH transmission. If Cₙ field is set to “1”, the QCL-typeD RS contained in the activated TCI state identified by TCI state ID_{n,2} and the power control parameter set identified by associated power control parameter set ID_{n,2} are used to determine a second TX beam and second power control parameter set for the scheduled PUSCH transmission.

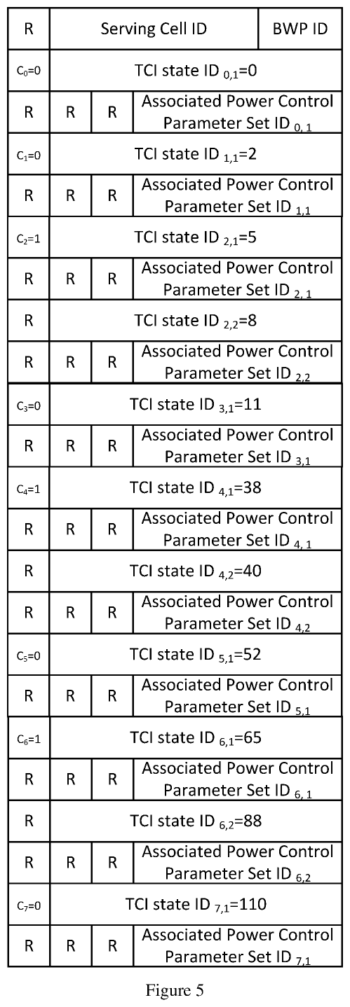

An example of the TCI state activation/deactivation MAC CE according to the fourth sub-embodiment is illustrated in FIG. 5.

For a UE supporting single-DCI based multi-TRP TDM based PDSCH transmission, the following TCI states shown in Table 2 are activated for the current active BWP by the MAC CE shown in FIG. 5. The associated power control parameter set ID_{n,1} or ID_{n,2} (n is from 0 to 71 fields are not applied for the scheduled PDSCH transmission.

```
TABLE 2
{
  TCI field with value of ‘000’ codepoints points to TCI state#0,
  TCI field with value of ‘001’ codepoints points to TCI-state#2,
  TCI field with value of ‘010’ codepoints points to TCI-state#5 and TCI-state#8,
  TCI field with value of ‘011’ codepoints points to TCI-state#11,
  TCI field with value of ‘100’ codepoints points to TCI-state#38 and TCI state#40,
  TCI field with value of ‘101’ codepoints points to TCI-state#52;
  TCI field with value of ‘110’ codepoints points to TCI-state#65 and TCI-state#88,
  TCI field with value of ‘111’ codepoints points to TCI-state#110
}
```

If the UE receives a DCI scheduling a PDSCH transmission, where the DCI includes a DL TCI field with value (i.e. TCI codepoint) ‘100’ and a field repetitionNumber-r16=2 (which is used to indicate the number of PDSCH repetitions in slot level), the UE shall receive the PDSCH transmission in 2 consecutive slots by using two RX beams determined by the QCL-TypeD RSs contained in the TCI state #38 and TCI state #40 indicated by TCI state ID_{4,1} and TCI state ID_{4,2}. That is, the UE receives the PDSCH transmission in a first slot by using the same spatial domain reception filter used for the reception of the QCL-TypeD RS contained in the TCI state #38 indicated by TCI state ID_{4,1} and receives the PDSCH transmission in a second consecutive slot by using the same spatial domain reception filter used for the reception of the QCL-TypeD RS contained in the TCI state #40 indicated by TCI state ID_{4,2}.

For a UE supporting single-DCI based multi-TRP TDM based PUSCH transmission, the same TCI states as shown in Table 2 are activated for the current active BWP by the MAC CE shown in FIG. 5. The associated power control parameter set ID_{n,1} or ID_{n,2} (n is from 0 to 7) fields are also applied for the scheduled PUSCH transmission.

If the UE receives a UL grant (i.e. DCI) scheduling a PUSCH transmission, where the UL grant includes a UL TCI field with value (i.e. TCI codepoint) ‘100’ and a field repetitionNumber-r16=2 (which is used to indicate the number of PUSCH repetition in slot level), the UE shall transmit the PUSCH transmission in 2 consecutive slots by two TX beams determined by the QCL-TypeD RS s contained in TCI state #38 and TCI state #40 indicated by TCI state ID_{4,1} and TCI state ID_{4,2} and with power control parameter sets indicated by associated power control parameter set ID_{4,1} and associated power control parameter set ID_{4,2}. That is, the UE transmits the PUSCH transmission in a first slot by the same spatial domain transmission filter used for the reception of the QCL-TypeD RS contained in TCI state #38 indicated by TCI state ID_{4,1} with the power determined by power control parameter set indicated by associated power control parameter set ID_{4,1}, and transmits the PUSCH transmission in a second consecutive slot by the same spatial domain transmission filter used for the reception of the QCL-TypeD RS contained in TCI state #40 indicated by TCI state ID_{4,2} with the power determined by power control parameter set indicated by associated power control parameter set ID_{4,2}.

In all of the description of the second embodiment, when the beam-specific power control for PUSCH transmission is supported, a power control parameter set is associated with each activated TCI state. According to a variety of the second embodiment, the power control parameter set can be replaced by a PL-RS. That is, a PL-RS identified by a PL-RS ID is associated with each activated TCI state. PUSCH-PathlossReferenceRS-r16 defined in NR Release 16 can be used as PL-RS indication. Up to 32 PL-RSs can be configured for a UE in a BWP. Therefore, the PL-RS associated with an activated TCI state can be represented by a PL-RS ID with 5 bits. In particular, the associated power control set ID n (n is from 0 to N) in FIGS. 1 to 3 or the associated power control set ID_{n,j} (n is from 0 to N, j is 1 or 2) in FIG. 4 can be replaced by associated PL-RS ID n (n is from 0 to N) or associated PL-RS ID_{n,j} (n is from 0 to N, j is 1 or 2).

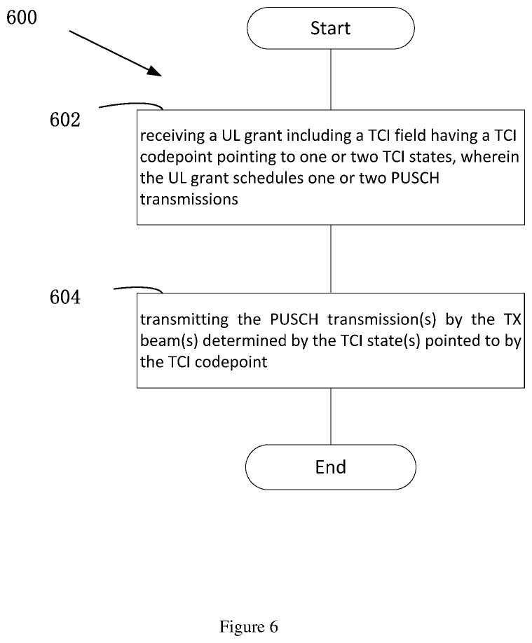

FIG. 6 is a schematic flow chart diagram illustrating an embodiment of a method 600 according to the present application. In some embodiments, the method 600 is performed by an apparatus, such as a remote unit. In certain embodiments, the method 600 may be performed by a processor executing program code, for example, a microcontroller, a microprocessor, a CPU, a GPU, an auxiliary processing unit, a FPGA, or the like.

The method 600 may include 602 receiving a UL grant including a TCI field having a TCI codepoint pointing to one or two TCI states, wherein the UL grant schedules one or two PUSCH transmissions; and 604 transmitting the PUSCH transmission(s) by the TX beam(s) determined by the TCI state(s) pointed to by the TCI codepoint.

In the method 600, the TX beam can be determined by a QCL-TypeD RS indicated by a first TCI state pointed to by the TCI codepoint. Alternatively, each of the TX beams is determined by a QCL-TypeD RS indicated by one of the two TCI states pointed to by the TCI codepoint.

Before the step 602, the method may further include receiving an RRC signaling to indicate whether the TCI field is included in the UL grant. If the TCI field is included in the UL grant, the TX beam(s) are determined by the TCI state(s) pointed to by the TCI codepoint as described in step 604 when the UL grant including the TCI field is received at step 602. If the TCI field is not included in the UL grant, the TX beam(s) can be determined differently, for example, determined by spatial relation(s) configured for SRS resource(s) indicated by a SRI field of the UL grant, or alternatively determined by the TCI state or QCL assumption indicated for the CORESET transmitting the PDCCH carrying the UL grant.

The method 600 may further include receiving a MAC CE indicating each TCI state and its associated power control parameter set for each TCI codepoint. The power control parameter set may include P0, alpha, closed loop index and PL-RS. The MAC CE may include a CORESET Pool ID field to indicate a CORESETPoolIndex of a CORESET transmitting the PDCCH carrying the UL grant, the TCI codepoint of the TCI field of which points to the one or two TCI states. When multi-beam PUSCH repetition is not configured, one associated power control parameter set is associated with a first TCI state even if two TCI states are pointed to by one TCI codepoint. When multi-beam PUSCH repetition is configured, if two TCI states are pointed to by one TCI codepoint, each of the two TCI states is associated with one associated power control parameter set.

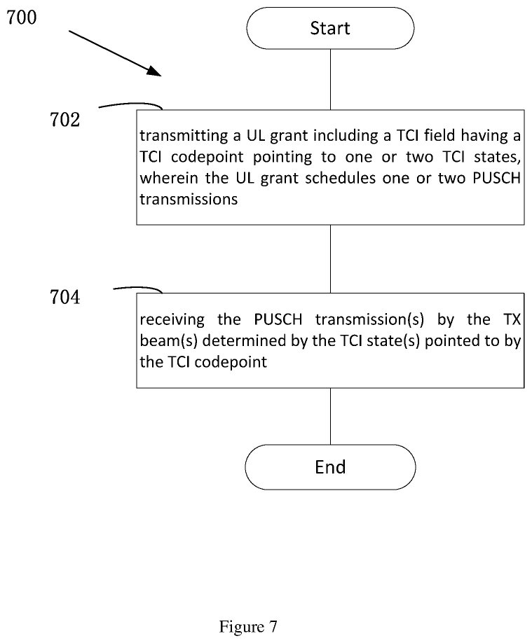

FIG. 7 is a schematic flow chart diagram illustrating an embodiment of a method 700 according to the present application. In some embodiments, the method 700 is performed by an apparatus, such as a base unit. In certain embodiments, the method 700 may be performed by a processor executing program code, for example, a microcontroller, a microprocessor, a CPU, a GPU, an auxiliary processing unit, a FPGA, or the like.

The method 700 may include 702 transmitting a UL grant including a TCI field having a TCI codepoint pointing to one or two TCI states, wherein the UL grant schedules one or two PUSCH transmissions; and 704 receiving the PUSCH transmission(s) by the TX beam(s) determined by the TCI state(s) pointed to by the TCI codepoint.

In the method 700, the TX beam can be determined by a QCL-TypeD RS indicated by a first TCI state pointed to by the TCI codepoint. Alternatively, each of the TX beams is determined by a QCL-TypeD RS indicated by one of the two TCI states pointed to by the TCI codepoint.

Before the step 702, the method may further include transmitting an RRC signaling to indicate whether the TCI field is included in the UL grant. If the TCI field is included in the UL grant, the TX beam(s) are determined by the TCI state(s) pointed to by the TCI codepoint as described in step 704 when the UL grant including the TCI field is transmitted at step 702. If the TCI field is not included in the UL grant, the TX beam(s) can be determined differently, for example, determined by spatial relation(s) configured for SRS resource(s) indicated by a SRI field of the UL grant, or alternatively determined by the TCI state or QCL assumption indicated for the CORESET transmitting the PDCCH carrying the UL grant.

The method 700 may further include transmitting a MAC CE indicating each TCI state and its associated power control parameter set for each TCI codepoint. The power control parameter set may include P0, alpha, closed loop index and PL-RS. The MAC CE may include a CORESET Pool ID field to indicate a CORESETPoolIndex value of a CORESET transmitting the PDCCH carrying the UL grant, the TCI codepoint of the TCI field of which points to the one or two TCI states. When multi-beam PUSCH repetition is not configured, one associated power control parameter set is associated with a first TCI state even if two TCI states are pointed to by one TCI codepoint. When multi-beam PUSCH repetition is configured, if two TCI states are pointed to by one TCI codepoint, each of the two TCI states is associated with one associated power control parameter set.

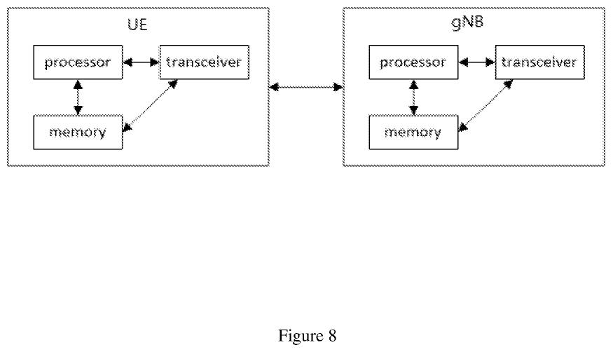

FIG. 8 is a schematic block diagram illustrating apparatuses according to one embodiment.

Referring to FIG. 8, the UE (i.e. the remote unit) includes a processor, a memory, and a transceiver. The processor implements a function, a process, and/or a method which are proposed in FIG. 6. In particular, the remote unit includes a receiver and a transmitter, the receiver receives a UL grant including a TCI field has a TCI codepoint pointing to one or two TCI states, wherein the UL grant schedules one or two PUSCH transmissions; and the transmitter transmits the PUSCH transmission(s) by the TX beam(s) determined by the TCI state(s) pointed to by the TCI codepoint.

The TX beam can be determined by a QCL-TypeD RS indicated by a first TCI state pointed to by the TCI codepoint. Alternatively, each of the TX beams is determined by a QCL-TypeD RS indicated by one of the two TCI states pointed to by the TCI codepoint.

The receiver of the remote unit may also receive an RRC signaling to indicate whether the TCI field is included in the UL grant. If the TCI field is included in the UL grant, the TX beam(s) are determined by the TCI state(s) pointed to by the TCI codepoint when the UL grant including the TCI field is received. If the TCI field is not included in the UL grant, the TX beam(s) can be determined differently, for example, determined by spatial relation(s) configured for SRS resource(s) indicated by a SRI field of the UL grant, or alternatively determined by the TCI state or QCL assumption indicated for the CORESET transmitting the PDCCH carrying the UL grant.

The receiver of the remote unit may also receive a MAC CE indicating each TCI state and its associated power control parameter set for each TCI codepoint. The power control parameter set may include P0, alpha, closed loop index and PL-RS. The MAC CE may include a CORESET Pool ID field to indicate a CORESETPoolIndex value of a CORESET transmitting the PDCCH carrying the UL grant, the TCI codepoint of the TCI field of which points to the one or two TCI states. When multi-beam PUSCH repetition is not configured, one associated power control parameter set is associated with a first TCI state even if two TCI states are pointed to by one TCI codepoint. When multi-beam PUSCH repetition is configured, if two TCI states are pointed to by one TCI codepoint, each of the two TCI states is associated with one associated power control parameter set.

The gNB (i.e. base unit) includes a processor, a memory, and a transceiver. The processors implement a function, a process, and/or a method which are proposed in FIG. 7. In particular, the base unit includes a transmitter and a receiver, the transmitter transmits a UL grant including a TCI field has a TCI codepoint pointing to one or two TCI states, wherein the UL grant schedules one or two PUSCH transmissions; and the receiver receives the PUSCH transmission(s) by the TX beam(s) determined by the TCI state(s) pointed to by the TCI codepoint.

The TX beam can be determined by a QCL-TypeD RS indicated by a first TCI state pointed to by the TCI codepoint. Alternatively, each of the TX beams is determined by a QCL-TypeD RS indicated by one of the two TCI states pointed to by the TCI codepoint.

The transmitter of the base unit may also transmit an RRC signaling to indicate whether the TCI field is included in the UL grant. If the TCI field is included in the UL grant, the TX beam(s) are determined by the TCI state(s) pointed to by the TCI codepoint when the UL grant including the TCI field is transmitted. If the TCI field is not included in the UL grant, the TX beam(s) can be determined differently, for example, determined by spatial relation(s) configured for SRS resource(s) indicated by a SRI field of the UL grant, or alternatively determined by the TCI state or QCL assumption indicated for the CORESET transmitting the PDCCH carrying the UL grant.

The transmitter of the base unit may also transmit a MAC CE indicating each TCI state and its associated power control parameter set for each TCI codepoint. The power control parameter set may include P0, alpha, closed loop index and PL-RS. The MAC CE may include a CORESET Pool ID field to indicate a CORESETPoolIndex value of a CORESET transmitting the PDCCH carrying the UL grant, the TCI codepoint of the TCI field of which points to the one or two TCI states. When multi-beam PUSCH repetition is not configured, one associated power control parameter set is associated with a first TCI state even if two TCI states are pointed to by one TCI codepoint. When multi-beam PUSCH repetition is configured, if two TCI states are pointed to by one TCI codepoint, each of the two TCI states is associated with one associated power control parameter set.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A method comprising:
transmitting a physical uplink shared channel (PUSCH) transmission by a transmit (TX) beam determined by a quasi-co-location (QCL) type D (QCL-TypeD) reference signal (RS) contained in a transmission configuration indicator (TCI) state, wherein the TCI state is associated with a set of power control parameters comprising P0, alpha, a closed loop index, a path loss (PL) RS, or any combination thereof.

2. (canceled)

3. (canceled)

4. The method of claim 1, further comprising:
receiving radio resource control (RRC) signaling to indicate whether a TCI field is included in an uplink (UL) grant, wherein,
if the TCI field is included in the UL grant, the TX beam is determined by the TCI state, and
if the TCI field is not included in the UL grant, the TX beam is determined by spatial relations configured for sounding reference signal (SRS) resources indicated by an SRS resource indicator (SRI) field of the UL grant, or determined by the TCI state or QCL assumption indicated for a control resource set (CORESET) transmitting a physical downlink control channel (PDCCH) carrying the UL grant.

5. The method of claim 1, further comprising:
receiving a MAC CE indicating the TCI state and its associated power control parameter set for a TCI codepoint.

6. (canceled)

7. The method of claim 5, wherein the MAC CE includes a CORESET pool identifier (ID) field to indicate a CORESETPoolIndex value of a CORESET transmitting a physical downlink control channel (PDCCH) carrying an UL grant.

8. The method of claim 5, wherein, when multi-beam PUSCH repetition is not configured, one associated power control parameter set is associated with the TCI state even if two TCI states are pointed to by one TCI codepoint.

9. The method of claim 5, wherein, when multi-beam PUSCH repetition is configured, if two TCI states are pointed to by one TCI codepoint, each of the two TCI states is associated with one associated power control parameter set.

10. A method comprising:
receiving a physical uplink shared channel (PUSCH) transmission by a transmit (TX) beam determined by a quasi-co-location (QCL) type D (QCL-TypeD) reference signal (RS) contained in a transmission configuration indicator (TCI) state, wherein the TCI state is associated with a set of power control parameters comprising P0, alpha, a closed loop index, a path loss (PL) RS, or any combination thereof.

11. An apparatus for wireless communication, the apparatus comprising:
a processor; and
a memory coupled to the processor, the memory comprising instructions executable by the processor to cause the apparatus to:
transmit a physical uplink shared channel (PUSCH) transmission by a transmit (TX) beam determined by a quasi-co-location (QCL) type D (QCL-TypeD) reference signal (RS) contained in a transmission configuration indicator (TCI) state, wherein the TCI state is associated with a set of power control parameters comprising P0, alpha, a closed loop index, a path loss (PL) RS, or any combination thereof.

12. (canceled)

13. The apparatus of claim 11, further comprising:
receiving radio resource control (RRC) signaling to indicate whether a TCI field is included in an uplink (UL) grant, wherein,
if the TCI field is included in the UL grant, the TX beam is determined by the TCI state, and
if the TCI field is not included in the UL grant, the TX beam is determined by spatial relations configured for sounding reference signal (SRS) resources indicated by an SRS resource indicator (SRI) field of the UL grant, or determined by the TCI state or QCL assumption indicated for a control resource set (CORESET) transmitting a physical downlink control channel (PDCCH) carrying the UL grant.

14. The apparatus of claim 11, further comprising:
receiving a MAC CE indicating a TCI state and its associated power control parameter set for a TCI codepoint.

15. The apparatus of claim 14, wherein the MAC CE includes a CORESET pool identifier (ID) field to indicate a CORESETPoolIndex value of a CORESET transmitting a physical downlink control channel (PDCCH) carrying an UL grant.

16. The apparatus of claim 14, wherein, when multi-beam PUSCH repetition is not configured, one associated power control parameter set is associated with the TCI state even if two TCI states are pointed to by one TCI codepoint.

17. The apparatus of claim 14, wherein, when multi-beam PUSCH repetition is configured, if two TCI states are pointed to by one TCI codepoint, each of the two TCI states is associated with one associated power control parameter set.
